(19) United States
(12) Patent Application Publication
(10) Pub. No.: US 2026/0277062 A1
(43) Pub. Date: Sep. 17, 2026

(54) ARRAY SUBSTRATE AND A DISPLAY PANEL

(71) Applicant: HKC CORPORATION LIMITED, Shenzhen (CN)

(72) Inventors: Chengshun ZHU, Shenzhen (CN); Zhonglin CAO, Shenzhen (CN); Hejun NING, Shenzhen (CN); Xueyong HUANG, Shenzhen (CN); Lidan YE, Shenzhen (CN)

(21) Appl. No.: 19/398,276

(22) Filed: Nov. 24, 2025

(30) Foreign Application Priority Data
Nov. 27, 2024 (CN) 202411710583.7

(51) Int. Cl. G02F 1/1362

(52) U.S. Cl. CPC G02F 1/136204; G02F 1/136286

(57) ABSTRACT

An array substrate and a display panel are provided. The array substrate includes a driving line and a static-electricity protection line. The driving line includes a first driving sub-line and a second driving sub-line. The first driving sub-line has a first connection portion. The second driving sub-line includes a first driving section, a second driving section, and a first static-electricity discharge portion. The first driving section includes a second connection portion at one end of the first driving section. The second connection portion is electrically connected to the first connection portion. The first static-electricity discharge portion is located at a joint of the another end of the first driving section and the second driving section. The static-electricity protection line includes a line body and a second static-electricity discharge portion. The second static-electricity discharge portion and the first static-electricity discharge portion are opposite to and spaced apart from each other.

### CROSS-REFERENCE TO RELATED APPLICATIONS

This application claims priority to Chinese Patent Application No. 202411710583.7, filed Nov. 27, 2024, the entire disclosure of which is incorporated herein by reference.

### TECHNICAL FIELD

This disclosure relates to the field of display technology, and particularly to an array substrate and a display panel.

### BACKGROUND

With the development of technology, electronic devices including liquid crystal display (LCD) panels have been used more and more widely. The LCD panel includes an array substrate. The array substrate is prone to be affected by static electricity to cause burning of lines on the array substrate, thereby causing product defects.

### SUMMARY

According to a first aspect, an embodiment of the present disclosure provides an array substrate. The array substrate includes a driving line and a static-electricity protection line. The driving line includes a first driving sub-line and a second driving sub-line. The first driving sub-line has a first connection portion. The second driving sub-line and the first driving sub-line are disposed in different layers. The second driving sub-line includes a first driving section, a second driving section, and a first static-electricity discharge portion. The first driving section includes a second connection portion at one end of the first driving section, and the second connection portion is electrically connected to the first connection portion. The second driving section is connected to another end of the first driving section facing away from the second connection portion in a bent manner. The first static-electricity discharge portion is located at a joint of the other another of the first driving section and the second driving section. The static-electricity protection line is disposed in the same layer as the second driving sub-line. The static-electricity protection line includes a line body and a second static-electricity discharge portion connected to the line body, and the second static-electricity discharge portion and the first static-electricity discharge portion are opposite to and spaced apart from each other.

According to a second aspect, an embodiment of the present disclosure provides a display panel, and the display panel includes an array substrate. The array substrate includes a driving line and a static-electricity protection line. The driving line includes a first driving sub-line and a second driving sub-line. The first driving sub-line has a first connection portion. The second driving sub-line and the first driving sub-line are disposed in different layers. The second driving sub-line includes a first driving section, a second driving section, and a first static-electricity discharge portion. The first driving section includes a second connection portion at one end of the first driving section, and the second connection portion is electrically connected to the first connection portion. The second driving section is connected to another end of the first driving section facing away from the second connection portion in a bent manner. The first static-electricity discharge portion is located at a joint of the another end of the first driving section and the second driving section. The static-electricity protection line is disposed in the same layer as the second driving sub-line. The static-electricity protection line includes a line body and a second static-electricity discharge portion connected to the line body, and the second static-electricity discharge portion and the first static-electricity discharge portion are opposite to and spaced apart from each other.

### BRIEF DESCRIPTION OF THE DRAWINGS

To describe technical solutions of embodiments of the present disclosure more clearly, the following will give a brief introduction to accompanying drawings used for describing embodiments. Apparently, the accompanying drawings hereinafter described are some embodiments of the disclosure. Based on these drawings, those of ordinary skill in the art can also obtain other drawings without creative effort.

FIG. 1 is a schematic diagram of a display panel provided in an embodiment of the present disclosure.

FIG. 2 is a cross-sectional schematic diagram of the display panel taken along line I-I in FIG. 1.

FIG. 3 is a partial top diagram of an array substrate provided in a first embodiment of the present disclosure.

FIG. 4 is a cross-sectional schematic diagram of the array substrate provided in FIG. 3 take along line II-II.

FIG. 5 is a partial schematic diagram of an array substrate provided in the first embodiment of the present disclosure.

FIG. 6 is a schematic diagram illustrating detailed dimensions of various positions in the array substrate illustrated in FIG. 5.

FIG. 7 is a dimension diagram of multiple different parts in the array substrate provided in the first embodiment of the present disclosure.

FIG. 8 is a partial top diagram of an array substrate provided in a second embodiment of the present disclosure.

FIG. 9 is a schematic diagram illustrating detailed dimensions of various positions in the array substrate illustrated in FIG. 8.

FIG. 10 is a dimension diagram of multiple different parts in the array substrate provided in the second embodiment of the present disclosure.

FIG. 11 is a partial top diagram of an array substrate provided in a third embodiment of the present disclosure.

FIG. 12 is a schematic diagram illustrating detailed dimensions of various positions in the array substrate illustrated in FIG. 11.

FIG. 13 is a dimension diagram of multiple different parts in the array substrate provided in the third embodiment of the present disclosure.

FIG. 14 is a flowchart of a manufacturing method of an array substrate provided in an embodiment of the present disclosure.

FIG. 15 is a schematic diagram of a display panel provided in an embodiment of the present disclosure.

DESCRIPTIONS OF REFERENCE SIGNS OF KEY COMPONENTS
display panel 10, display region 10a, and a non-display region 10b; array substrate 100, color filter substrate 300, liquid crystal layer 500, and housing 600;
support substrate 101, driving line 110, first driving line 110a, second driving line 110b, third driving line 110c, first driving sub-line 111, connection piece 111a, second driving sub-line 112, first line body 1111, first connection portion 1112, first driving section 1121, second driving section 1122, first static-electricity discharge portion 1123, first end face 112a, and second connection portion 1121;
insulation layer 120, and through hole 121;
static-electricity protection line 130, line body 131, second static-electricity discharge portion 132, second end face 130a.

### DETAILED DESCRIPTION

The following clearly and completely describes technical solutions in embodiments of the present disclosure with reference to accompanying drawings in embodiments of the present disclosure. Apparently, the described embodiments are merely a part rather than all of embodiments of the present disclosure. All other embodiments obtained by a person of ordinary skill in the art based on embodiments of the present disclosure without creative efforts shall belong to the scope of protection of the present disclosure.

The terms “first”, “second”, and the like in the description and claims of the present disclosure and the accompanying drawings are used for distinguishing different objects, rather than for describing a specific order. Furthermore, the terms “include” and “have” and any variations thereof are intended to cover non-exclusive inclusions. For example, a process, method, system, product, or apparatus that includes a series of steps or units is not limited to the listed steps or units, but optionally further includes steps or units not listed, or optionally further includes other steps or units inherent to the process, method, product, or apparatus.

“Embodiment” or “implementation” involved herein means that a particular feature, structure, or characteristic described with reference to an embodiment or implementation can be included in at least one embodiment of the present disclosure. The appearances of this phrase in various places in the description does not necessarily refer to the same embodiment, nor does it refer to an independent or alternative embodiment that is mutually exclusive with other embodiments. It is expressly and implicitly understood by those skilled in the art that an embodiment described herein may be combined with other embodiments.

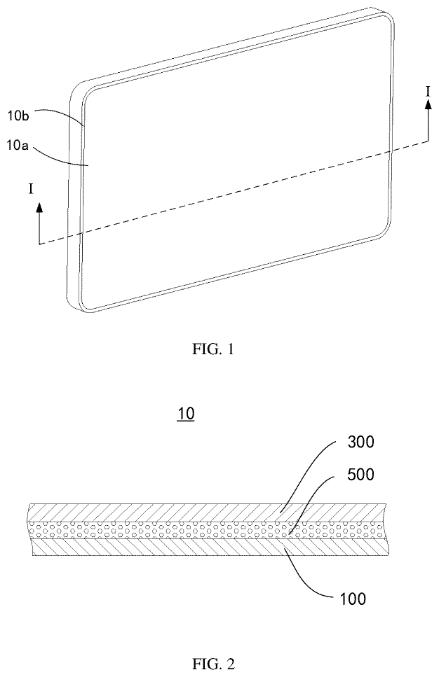

Reference is made to FIGS. 1 and 2, where FIG. 1 is a schematic diagram of a display panel provided in an embodiment of the present disclosure and FIG. 2 is a cross-sectional schematic diagram of the display panel taken along line I-I in FIG. 1. The display panel 10 is also referred to as a display device. In the present embodiment, the display panel 10 is exemplified by a liquid crystal display (LCD) panel, and it may be understood that the display panel 10 provided in embodiments of the present disclosure shall not be construed as a limitation thereto. In other embodiments, the display panel 10 may also be an organic electroluminescence (OLED) display panel, a mini-light emitting diode (Mini-LED) display panel, or the like.

When the display panel 10 is an LCD panel, the display panel 10 includes an array substrate 100, a color filter substrate 300, and a liquid crystal layer 500. The array substrate 100 and the color filter substrate 300 are disposed opposite to and spaced apart from each other to form an accommodation space, and the liquid crystal layer 500 is disposed in the accommodation space. It can be understood that the display panel 10 in embodiments of the present disclosure is only an illustration to an application situation of the array substrate 100, and may not be understood as a limitation to the array substrate 100 provided in embodiments of the present disclosure.

The display panel 10 includes an array substrate 100, and the display panel 10 has a display region 10a and a non-display region 10b. The array substrate 100 includes multiple pixel regions at positions corresponding to the display region 10a, and the array substrate 100 includes thin film transistors (TFTs) corresponding to the pixel regions. In the related art, the thin film transistor is an amorphous silicon semiconductor thin film transistor (a-Si TFT) or a low temperature polysilicon semiconductor thin film transistor. With the development of technology, metal oxide semiconductor materials with high mobility are widely used in various display panels 10 to replace amorphous silicon semiconductor thin film transistors or replace low temperature polysilicon semiconductor thin film transistors. Compared with an amorphous silicon semiconductor thin film transistor (a-Si TFT), an oxide semiconductor thin film transistor (Oxide TFT) has more advantages in performance, can meet technical requirements, such as high-resolution, high refresh rate, high transfertance, ultra-low power consumption, of advanced LCD and OLED display products, demonstrating stronger overall competitiveness.

However, the metal oxide semiconductor thin film transistor in the related art is vulnerable to static-electricity impact during manufacturing tolerances. On one hand, high-generation production lines are generally used when the metal oxide semiconductor thin film transistor is manufactured, the amount of static electricity generated by the process equipment is large and is not easy to control. On the other hand, the metal oxide semiconductor thin film transistor has a high carrier concentration and is more likely to accumulate static electricity on the surface of the substrate. In the static-electricity protection design in the related art, due to low breakdown voltage resistance and concentrated static-electricity discharge, it is easy to cause burning of the driving line 110 and other lines in the array substrate 100, resulting in product defects. In the related art, product yield loss (also referred to as yield loss) due to static-electricity causes is as high as 20%.

An embodiment of the present disclosure provides an array substrate 100, and the array substrate 100 has a better static-electricity protection capability, and the array substrate 100 provided in the embodiment of the present disclosure will be described in detail below.

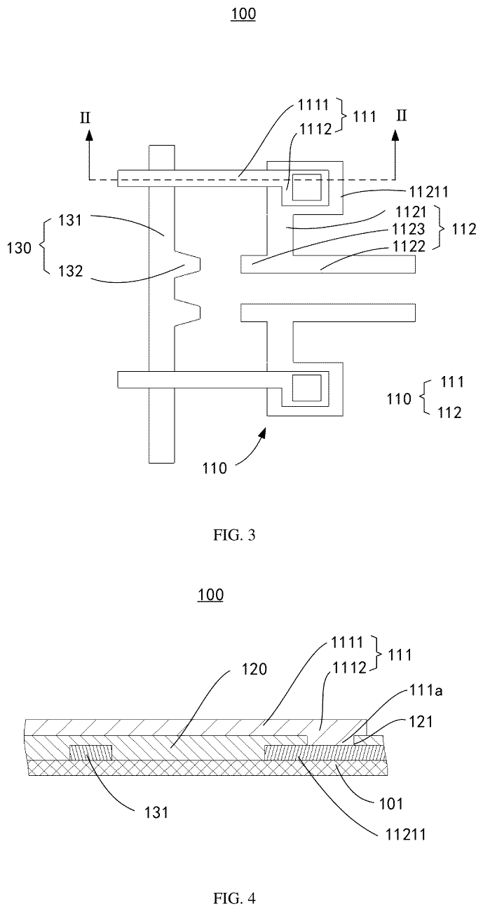

Reference is made to FIGS. 3 and 4 together, where FIG. 3 is a partial top diagram of an array substrate provided in a first embodiment of the present disclosure, and FIG. 4 is a cross-sectional schematic diagram of the array substrate provided in FIG. 3 taken along line II-II. The array substrate 100 includes a driving line 110 and a static-electricity protection line 130. The driving line 110 includes a first driving sub-line 111 and a second driving sub-line 112. The first driving sub-line 111 includes a first connection portion 1112, and the second driving sub-line 112 and the first driving sub-line 111 are disposed in different layers. The second driving sub-line 112 includes a first driving section 1121, a second driving section 1122, and a first static-electricity discharge portion 1123. The first driving section 1121 includes a second connection portion 11211 at one end of the first driving section 1121. The second connection portion 11211 is electrically connected to the first connection portion 1112. The second driving section 1122 is connected to the other end of the first driving section 1121 facing away from the second connection portion 11211 in a bent manner. The first static-electricity discharge portion 1123 is located at a joint between the other end of the first driving section 1121 and the second driving section 1122. The static-electricity protection line 130 is disposed in the same layer as the second driving sub-line 112. The static-electricity protection line 130 includes a line body 131 and a second static-electricity discharge portion 132 connected to each other. The second static-electricity discharge portion 132 is opposite to and spaced apart from the first static-electricity discharge portion 1123.

In the present embodiment, the array substrate 100 further includes a support substrate 101 for bearing the driving line 110 and the static-electricity protection line 130.

The driving line 110 in the array substrate 100 may be made of, but is not limited to, conductive metal, alloy, or the like. The driving line 110 may be of a single layer, or multiple layers (e. g., two or more layers). The material of the driving line 110 may be, but is not limited to, one or more of Cu, Mo, Al, Ti, Nb, and Mg.

In the present embodiment, the array substrate 100 includes a thin film transistor (TFT). The driving line 110 is electrically connected to the thin film transistor, and thus the driving line 110 is also referred to as a TFT driving line 110.

In this embodiment, the second driving sub-line 112 is closer to the support substrate 101 than the first driving sub-line 111. It can be understood that, in other embodiments, the second driving sub-line 112 is farther away from the support substrate 101 than the first driving sub-line 111. It suffices that the second driving sub-line 112 and the first driving sub-line 111 are disposed in different layers.

The first sub-driving line 111 has a first line body 1111 and a first connection portion 1112, and the first connection portion 1112 is connected to the first line body 1111. At least a part of the first line body 1111 is located in the non-display region 10b of the display panel 10 to which the array substrate 100 is applied. A line width of the first connection portion 1112 is greater than a line width of the first line body 1111.

The second driving sub-line 112 and the first driving sub-line 111 are disposed in different layers, for example, an insulation layer 120 is disposed between the second driving sub-line 112 and the first driving sub-line 111. The insulation layer 120 defines a through hole 121 corresponding to the first connection portion 1112 and the second connection portion 11211. A connection piece 111a is disposed in the through hole 121, and the connection piece 111a is connected to the first connection portion 1112 and the second connection portion 11211. In one embodiment, the connection piece 111a and the first connection portion 1112 are of an integral structure.

The material of the insulation layer 120 may include, but is not limited to, one or more of silicon oxide, silicon nitride, and silicon oxynitride. The number of layers of the insulation layer 120 may be, but is not limited to, one, or greater than or equal to two. In one embodiment, when there are multiple insulation layers 120, and the second driving sub-line 112 is closer to the support substrate 101 than the first driving sub-line 111, among the multiple insulation layers 120, an insulation layer 120 close to the second driving sub-line 112 is one of two film layers: silicon nitride film layer and silicon oxynitride film layer, and an insulation layer 120 facing away from the second driving sub-line 112 is a silicon oxide film layer.

At least part of the second driving sub-line 112 is located in the display region 10a of the display panel 10 to which the array substrate 100 is applied. The second driving sub-line 112 is configured to be electrically connected to thin film transistors disposed in the display region 10a. Specifically, the second driving sub-line 112 includes a first driving section 1121, a second driving section 1122, and a first static-electricity discharge portion 1123. The first driving section 1121 includes a second connection portion 11211 at one end of the first driving section 1121. Accordingly, a line width of the second connection portion 11211 is greater than a line width of the remaining part of the first driving section 1121.

The line width of the first connection portion 1112 is greater than the line width of the first line body 1111, and the line width of the second connection portion 11211 is greater than the line width of the remaining part of the first driving section 1121. Therefore, when the first connection portion 1112 is electrically connected to the second connection portion 11211, the electrical connection between the first sub-driving line 111 and the second sub-driving line 112 can be better.

One end of the second driving section 1122 facing away from the second connection portion 11211 is configured to be electrically connected to a thin film transistor. The first static-electricity discharge portion 1123 is located at a joint between the first driving section 1121 and the other end of the second driving section 1122. Therefore, the first static-electricity discharge portion 1123 is far away from a joint between the first connection portion 1112 and the second connection portion 1121. Furthermore, the first static-electricity discharge portion 1123 is also far away from the thin film transistor, thus, when the first static-electricity discharge portion 1123 and the second static-electricity discharge portion 132 discharge static electricity, it is not easy to damage the thin film transistor n the array substrate 100, and it is also not easy to damage the joint between the second connection portion 1111 and the first connection portion 1112.

The static-electricity protection line 130 may be made of, but is not limited to, a conductive metal, an alloy, or the like. The static-electricity protection line 130 may be of a single layer, or multiple layers (e. g., two or more layers). The material of the static-electricity protection line 130 may be, but not limited to, one or more of Cu, Mo, Al, Ti, Nb, and Mg.

In one embodiment, the static-electricity protection line 130 is disposed in the non-display region 10b of the display panel 10 to which the array substrate 100 is applied. The static-electricity protection line 130 and the second driving sub-line 112 are disposed in the same layer, and there is a gap between the static-electricity protection line 130 and the second sub-driving elements. The static-electricity protection line 130 includes a line body 131 and a second static-electricity discharge portion 132, and the line body 131 and the second driving sub-line 112 are spaced apart from each other. The second static-electricity discharge portion 132 is disposed on one side of the line body 131 adjacent to the first static-electricity discharge portion 1123. The second static-electricity discharge portion 132 at least partially faces the first static-electricity discharge portion 1123. In the present embodiment, for example, the second static-electricity discharge portion 132 is right opposite to the first static-electricity discharge portion 1123, which may not be construed as a limitation to embodiment of the present disclosure as can be understood.

In this embodiment, for illustrative purpose, an orthographic projection of the first static-electricity discharge portion 1123 on the support substrate 101 is rectangular, and an orthographic projection of the second static-electricity discharge portion 132 on the support substrate 101 is trapezoid.

When static electricity is present (for example, static electricity is generated during the manufacturing process of the array substrate 100 or during the usage process of the array substrate 100), the static electricity in the driving line 110 is released to the second static-electricity discharge portion 132 via the first static-electricity discharge portion 1123, so as to prevent the static electricity in the driving line 110 from damaging the driving line 110.

In summary, the array substrate 100 provided in embodiments of the present disclosure includes the driving line 110 and the static-electricity protection line 130, the driving line 110 includes the first static-electricity discharge portion 1123, the static-electricity protection line 130 include the second static-electricity discharge portion 132, and the second static-electricity discharge portion 132 and the first static-electricity discharge portion 1123 are opposite to each other and spaced from each other. When static electricity is present in the array substrate 100 during the manufacturing process or in the usage process, the static electricity may be released to the second static-electricity discharge portion 132 via the first static-electricity discharge portion 1123, so as to reduce or even prevent the risk of burning or breaking down the driving line 110 or other devices in the array substrate 100 due to static-electricity accumulation in the array substrate 100. It can be seen that the array substrate 100 provided in embodiments of the present disclosure has a high yield rate, and when the array substrate 100 is applied to a display panel 10, the display quality of the display panel 10 is high. In addition, in the array substrate 100 provided in embodiments of the present disclosure, the first static-electricity discharge portion 1123 is located at the joint of the first driving section 1121 and the other end of the second driving section 1122. Therefore, the first static-electricity discharge portion 1123 is far away from the joint between the first connection portion 1112 and the second connection portion 1121. Furthermore, the first static-electricity discharge portion 1123 is also far away from the thin film transistor. When the first static-electricity discharge portion 1123 and the second static-electricity discharge portion 132 discharge static electricity, it is not easy to damage the thin film transistor of the array substrate 100, and it is also not easy to damage the joint of the second connection portion 1111 and the first connection portion 1112, so that the display quality of the display panel 10 applied to the array substrate 100 is further improved.

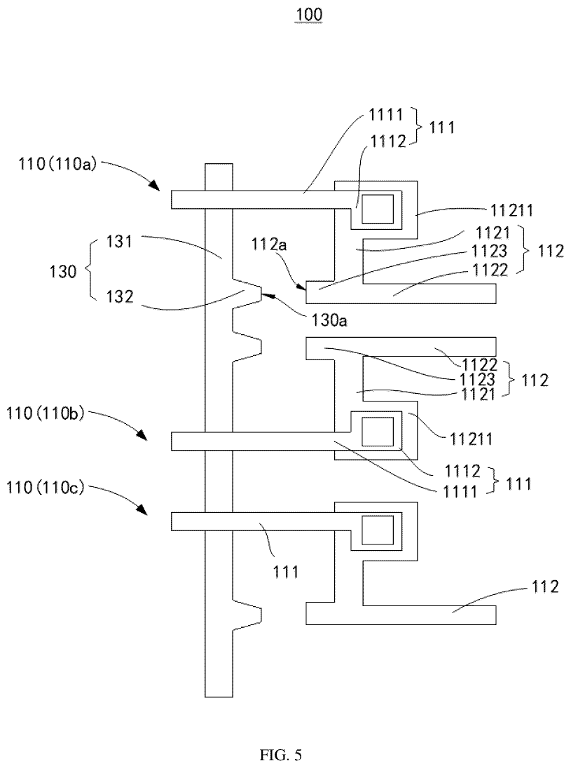

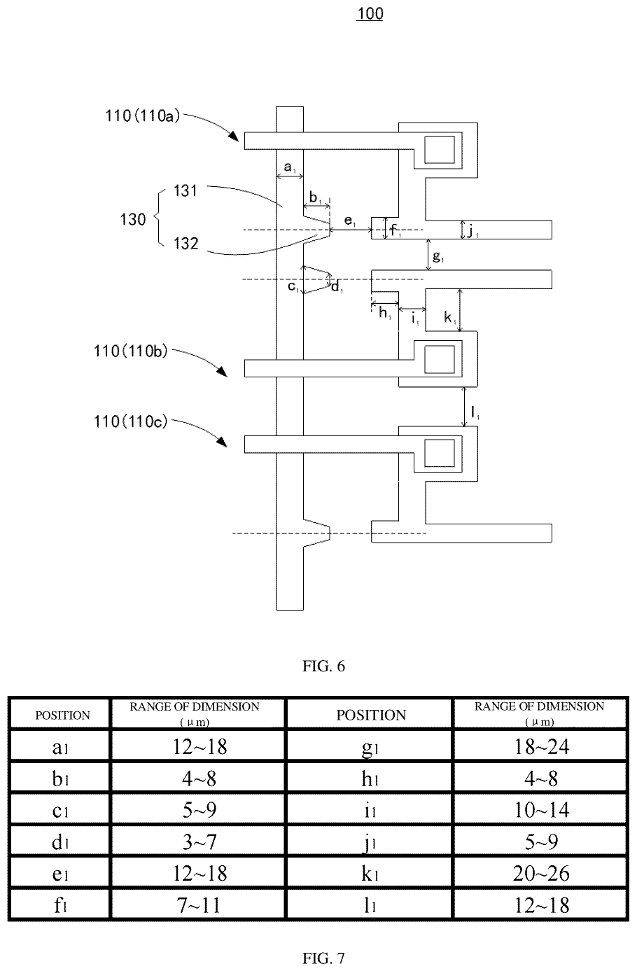

Reference is made to FIGS. 3, 5 and 6 together, where FIG. 5 is a partial schematic diagram of an array substrate provided in the first embodiment of the present disclosure, and FIG. 6 is a schematic diagram illustrating detailed dimensions of various positions of the array substrate illustrated in FIG. 5. The difference between FIG. 5 and FIG. 3 lies in that the array substrate illustrated in FIG. 5 schematically illustrated more driving lines 110.

In order to conveniently describe parameters of various components in the array substrate 100 provided in respective embodiments, the parameters of the various components in the array substrate 100 in the respective embodiments are identified by xₙ, where x is a parameter of each of the various components, for example, x=a, b, c, d, or the like, and n=1, 2, or 3, the first embodiment is identified with 1, the second embodiment is identified with 2, and the third embodiment is identified with 3. In one embodiment, the line width a of the line body 131 satisfies: 12 μm≤a≤18 μm. For example, in the array substrate 100 provided in the first embodiment, the line width a₁ of the line body 131 satisfies: 12 μm≤a₁≤18 μm.

In this embodiment, the line width a₁ of the line body 131 may be, but is not limited to, 12 μm, 13 μm, 14 μm, 15 μm, 16 μm, 17 μm, or 18 μm.

If the line width a₁ of the line body 131 is too small, when the static electricity is transferred to the line body 131 via the second static-electricity discharge portion 132, the line body 131 is easily burned. If the line width a₁ of the line body 131 is too large, the non-display region 10b of the display panel 10 to which the array substrate 100 is applied is wider. In the array substrate 100 provided in the embodiment of the present disclosure, the line body 131 of the static-electricity protection line 130 has the line width a₁ satisfying: 12 μm≤a₁≤18 μm, so that on one hand, the static electricity transferred to the line body 131 via the second static-electricity discharge portion 132 is unlikely to damage the line body 131, and on the other hand, the non-display region 10b of the display panel 10 to which the array substrate 100 is applied is made narrower.

Reference is made to FIGS. 3, 5, and 6 again, the first static-electricity discharge portion 1123 is rectangular and the second static-electricity discharge portion 132 is trapezoid. The width of the top edge of the second static-electricity discharge portion 132 is d₁, and the width of the bottom edge of the second static-electricity discharge portion 132 is c₁, where c₁−d₁≥2 μm, 5 μm≤c₁≤9 μm, and 3 μm≤d₁≤7 μm.

In this embodiment, the second static-electricity discharge portion 132 is trapezoid, and the width of the top edge of the second static-electricity discharge portion 132 is less than the width of the bottom edge of the second static-electricity discharge portion 132. Therefore, the second static-electricity discharge portion 132 and the first static-electricity discharge portion 1123 can form point discharge better, so that the static electricity at the first static-electricity discharge portion 1123 can be released to the second static-electricity discharge portion 132 better.

In addition, the width of the top edge of the second static-electricity discharge portion 132 is d₁, and the width of the bottom edge of the second static-electricity discharge portion 132 is c₁, where c₁−d₁≥2 μm. For example, c₁−d₁ may be, but is not limited to, 2.0 μm, 2.5 μm, 3.0 μm, 3.5 μm, 4.0 μm, 4.5 μm, 5.0 μm, 5.5 μm, or 6.0 μm.

The bottom edge c₁ of the second static-electricity discharge portion 132 may be, but is not limited to, 5.0 μm, 5.5 μm, 6.0 μm, 6.5 μm, 7.0 μm, 7.5 μm, 8.0 μm, 8.5 μm, or 9.0 μm.

The width d₁ of the top edge of the second static-electricity discharge portion 132 may be, but is not limited to, 3.0 μm, 3.5 μm, 4.0 μm, 4.5 μm, 5.0 μm, 5.5 μm, 6.0 μm, 6.5 μm, or 7.0 μm.

The second static-electricity discharge portion 132 is trapezoid and has the top edge with the width of d₁ and the bottom edge with the width of c₁, where c₁−d₁≥2 μm, 5 μm≤c₁≤9 μm, and 3 μm≤d₁≤7 μm. In this way, a tip may be formed between side edges and the top edge of the second static-electricity discharge portion 132, and thus the second static-electricity discharge portion 132 and the first static-electricity discharge portion 1123 can form point discharge better. As a result, the static electricity at the first static-electricity discharge portion 1123 can be released to the second static-electricity discharge portion 132 better.

Reference is made to FIGS. 3, 5 and 6, the first static-electricity discharge portion 1123 has a first end surface 112a facing away from the second driving section 1122, and the second static-electricity discharge portion 132 has a second end surface 130a facing away from the line body 131. The second end surface 130a is at least partially right opposite to the first end surface 112a, and a distance e₁ between the first end surface 112a and the second end surface 130a satisfies: 12 μm≤e₁≤18 μm.

For example, the distance e₁ between the second end surface 130a and the first end surface 112a may be, but is not limited to, 12 μm, or 13 μm, 14 μm, 15 μm, 16 μm, 17 μm, or 18 μm.

When the distance between the first end surface 112a and the second end surface 130a is too small, even if the static electricity of the first static-electricity discharge portion 1123 may be released to the second static-electricity discharge portion 132, the too small distance between the first static-electricity discharge portion 1123 and the second static-electricity discharge portion 132 will lead to burning of the first static-electricity discharge portion 1123 when the static electricity is released. When the distance between the first end surface 112a and the second end surface 130a is too large, the static electricity of the first static-electricity discharge portion 1123 is not easily transferred to the second static-electricity discharge portion 132, thereby increasing the risk of the driving line 110 and other components (such as TFT) of the array substrate 100 being damaged by static electricity.

In the array substrate 100 provided in the embodiment of the present disclosure, the distance e₁ between the first end face 112a and the second end face 130a satisfies: 12 μm≤e₁≤18 μm. In this case, the distance between the first end surface 112a and the second end surface 130a is moderate, so that on one hand, the static electricity can be easily released to the second static-electricity discharge portion 132 via the first static-electricity discharge portion 1123, and the risk of static-electricity explosion of the driving line 110 and other components of the array substrate 100 is reduced; on the other hand, the first static-electricity discharge portion 1123 is not easily burned.

In one embodiment, a centerline of the first end surface 112a coincides with a centerline of the second end surface 130a. When the centerline of the first end surface 112a and the centerline of the second end surface 130a coincide with each other, and when the static electricity is transferred to the second static-electricity discharge portion 132 via the first static-electricity discharge portion 1123, the static electricity can be transferred to the sharp corner formed by two side edges and the top edge of the second static-electricity discharge portion 132 evenly, so that the second static-electricity discharge portion 132 is not easily burned.

Further, in one embodiment, the width d₁ of the top edge of the second static-electricity discharge portion 132 is the width of the second end surface 130a, therefore, the width of the second end surface 130a is also identified as d₁, and the width d₁ of the second end surface 130a and the width f1 of the first end surface 112a satisfy that: d₁<f1, 3 μm≤d₁≤7 μm, and 7 μm ≤f1≤11 μm.

The width d₁ of the second end surface 130a may be, but is not limited to, 3 μm, or 4 μm, 5 μm, 6 μm, 7 μm. The width f1 of the first end surface 112a may be, but is not limited to, 7 μm, 8 μm, 9 μm, 10 μm, or 11 μm.

In the array substrate 100 provided in the embodiment of the present disclosure, d₁<f1, 3 μm≤d₁≤7 μm, and 7 μm≤f1≤11 μm. On one hand, it is easier to form point discharge between the first static-electricity discharge portion 1123 and the second static-electricity discharge portion 132. Further, the static electricity of the first static-electricity discharge portion 1123 is more likely to be guided to the second static-electricity discharge portion 132, thereby reducing the risk of burning or breaking down the driving line 110 or other devices in the array substrate 100 by preventing static-electricity accumulation in the array substrate 100. On the other hand, the first static-electricity discharge portion 1123 and the second static-electricity discharge portion 132 can be made smaller in size, which facilitates arrangement in the array substrate 100.

Reference is made to FIGS. 3, 5, and 6 again, a distance k₁ from the second connection portion 11211 to the second driving section 1122 satisfies: 20 μm≤k₁≤26 μm.

For example, the distance k₁ from the second connection portion 1121 to the second driving section 1122 may be, but is not limited to, 20 μm, 21 μm, 22 μm, 23 μm, 24 μm, 25 μm, or 26 μm.

When the distance k₁ between the second connection portion 11211 and the second driving section 1122 is small, the static electricity of the first static-electricity discharge portion 1123 may damage the joint between the second connection portion 11211 and the first connection portion 1112. When the distance k₁ between the second connection portion 11211 and the second driving section 1122 is large, the number of the driving lines 110 arranged on the array substrate 100 is small, so that the resolution of the display panel 10 applied to the array substrate 100 is low.

In the array substrate 100 provided in the embodiment of the present disclosure, the first static-electricity discharge portion 1123 is located at the joint between the first driving section 1121 and the other end of the second driving section 1122. Therefore, when the distance k₁ between the second connection portion 11211 and the second driving section 1122 satisfies: 20 μm≤k₁≤26 μm, on one hand, the first static-electricity discharge portion 1123 is far away from the joint between the second connection portion 1121 and the first connection portion 1112, the probability that the static electricity of the first static-electricity discharge portion 1123 damages the joint between the second connection portion 11211 and the first connection portion 1112 can be reduced. On the other hand, the display panel 10 to which the array substrate 100 is applied can have a higher resolution.

Further, reference is made to FIGS. 5 and 6, the array substrate 100 provided in the embodiment of the present disclosure further includes multiple driving lines 110. In the present embodiment, for illustrative purpose, the array substrate 100 includes three driving lines 110, and which may not be understood as a limitation to the array substrate 100 provided in embodiments of the present disclosure.

In this embodiment, the three driving line 110 is identified as a first driving line 110a, a second driving line 110b, and a third driving line 110c, respectively. The first driving sub-line 111 of the second driving line 110b is disposed on one side of the second driving sub-line 112 of the first driving line 110a facing away from the first driving sub-line 111 of the first driving line 110a, and the first driving sub-line 111 of the second driving line 110b and the first driving sub-line 111 of the first driving line 110a are opposite to each other and spaced apart from each other. The second driving sub-line 112 of the second driving line 110b is disposed closer to the second driving sub-line 112 of the first driving line 110a than the first driving sub-line 111 of the second driving line 110b.

In this embodiment, a distance g₁ between the second sub-driving line 112 of the first driving line 110a and the second sub-driving line 112 of the first driving line 110a satisfies 18 μm≤g₁≤24 μm.

For example, the g₁ may be, but is not limited to, 18 μm, 19 μm, 20 μm, 21 μm, 22 μm, 23 μm, or 24 μm.

When the distance g₁ between the second driving sub-line 112 of the first driving line 110a and the second driving sub-line 112 of the first driving line 110a satisfies 18 μm≤g₁≤24 μm, the distance between the first driving line 110a and the second driving line 110b that are adjacent to each other is moderate, and it is able to meet the resolution requirements of the display panel 10 to which the array substrate 100 is applied and meet the requirements that the first driving line 110a and the second driving line 110b that are adjacent to each other discharge static-electricity through the same static-electricity protection line 130.

Further, the first driving sub-line 111 of the third driving line 110c and the first driving sub-line of the second driving line 110b are spaced apart from each other, and the first driving sub-line 111 of the third driving line 110c is disposed on one side of the first driving sub-line 111 of the second driving line 110b facing away from the second driving sub-line 112 of the second driving line 110b. The second driving sub-line 112 of the third driving line 110c is disposed on one side of the first driving sub-line 111 of the third driving line 110c facing away from the first driving sub-line 111 of the second driving line 110b.

In this embodiment, a distance l₁ between the second connection portion 11211 of the second driving line 110b and the second connection portion 11211 of the third driving line 110c satisfies: 12 μm≤l₁≤18 μm.

For example, the l₁ may be, but is not limited to, 12 μm, 13 μm, 14 μm, 15 μm, 16 μm, 17 μm, or 18 μm.

When the distance l₁ between the second connection portion 1121 of the second driving line 110b and the second connection portion 1121 of the third driving line 110c satisfies: 12 μm≤l₁≤18 μm, on one hand, the distance between the second driving line 110b and the third driving line 110c which are adjacent to each other can be moderate, so that it is able to meet the resolution requirements of the display panel 10 to which the array substrate 100 is applied and meet the requirements that the second driving line 110b and third driving line 110c that are adjacent to each other discharge static-electricity through the same static-electricity protection line 130.

Reference is made to FIG. 7, where FIG. 7 is a dimension diagram of multiple different parts in the array substrate provided in the first embodiment of the present disclosure. For example, when the array substrate 100 is applied to a 27UD DRD display panel 10 and the thin film transistor in the array substrate 100 is a metal oxide thin film transistor, each parameter of the array substrate 100 provided in the present embodiment reduces the yield loss of the array substrate 100 due to static electricity to 0%.

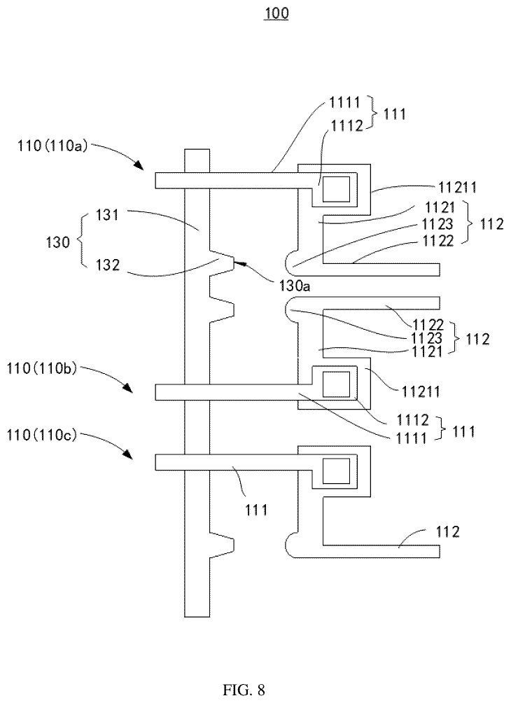

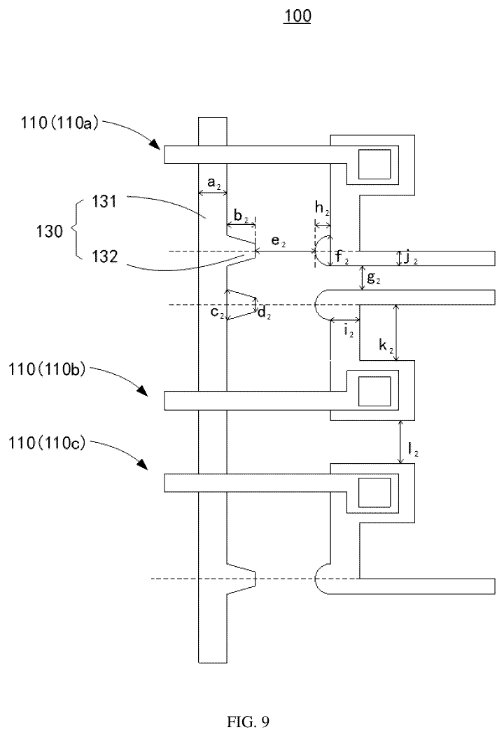

Reference is made to FIGS. 8 and 9, where FIG. 8 is a partial top diagram of an array substrate provided in a second embodiment of the present disclosure, and FIG. 9 is a schematic diagram illustrating detailed dimensions of the array substrate illustrated in FIG. 8. The array substrate 100 includes a driving line 110 and a static-electricity protection line 130. The driving line 110 include a first driving sub-line 111 and a second driving sub-line 112. The first driving sub-line 111 includes a first connection portion 1112. The second driving sub-line 112 and the first driving sub-line 111 are disposed in different layers. The second driving sub-line 112 includes a first driving section 1121, a second driving section 1122, and a first static-electricity discharge portion 1123. The first driving section 1121 includes a second connection portion 11211 at one end of the first driving section 1121. The second connection portion 11211 is electrically connected to the first connection portion 1112. The second driving section 1122 is connected to the other end of the first driving section 1121 facing away from the second connection portion 11211 in a bent manner. The first static-electricity discharge portion 1123 is located at a joint between the first driving section 1121 and the other end of the second driving section 1122. The static-electricity protection line 130 is disposed in the same layer as the second driving sub-line 112, and the static-electricity protection line 130 includes a line body 131 and a second static-electricity discharge portion 132 connected to each other. The second static-electricity discharge portion 132 is opposite to the first static-electricity discharge portion 1123 and is spaced from the first static-electricity discharge portion 1123.

Reference can be made to the above description for the driving line 110 and the static-electricity protection line 130, which will not be repeated here.

In this embodiment, a line width a₂ of the line body 131 satisfies: 12 μm≤a₂≤18 μm.

In this embodiment, the line width a₂ of the line body 131 may be, but is not limited to, 12 μm, 1 3 μm, 14 μm, 15 μm, 16 μm, 17 μm, or 18 μm.

If the line width a₂ of the line body 131 is too small, when the static electricity is transferred to the line body 131 via the second static-electricity discharge portion 132, the line body 131 is easily burned. When the line width a₂ of the line body 131 is too large, the non-display region 10b of the display panel 10 to which the array substrate 100 is applied becomes wider. In the array substrate 100 provided in the embodiment of the present disclosure, the line body 131 of the static-electricity protection line 130 has a line width a₂ satisfying: 12 μm≤a₂≤18 μm, so that on one hand, static electricity transferred to the line body 131 through the second static-electricity discharge portion 132 is unlikely to damage the line body 131; on the other hand, the non-display region 10b of the display panel 10 to which the array substrate 100 is applied is made narrower.

In addition, the array substrate 100 provided in the second embodiment of the present disclosure differs from the array substrate 100 provided in the first embodiment in that, the first static-electricity discharge portion 1123 is arc-shaped and the second static-electricity discharge portion 132 is trapezoid. A width of the top edge of the second static-electricity discharge portion 132 is d₂, and a width of the bottom edge of the second static-electricity discharge portion 132 is c₂, where c₂−d₂≥2 μm, 5 μm≤c₂≤9 μm, and 3 μm≤d₂≤7 μm. A width f₂ of a portion of the first static-electricity discharge portion 1123 connected to the joint satisfies: c₂<f₂.

In this embodiment, a surface of the first static-electricity discharge portion 1123 facing the second static-electricity discharge portion 132 is an arc surface. Therefore, the first static-electricity discharge portion 1123 can better disperse the static electricity accumulation in the driving line 110, and can better transfer the static electricity from the first static-electricity discharge portion 1123 to the second static-electricity discharge portion 132, thereby reducing or even preventing the static electricity accumulation in the array substrate 100 from causing the risk of burning or breakdown of the driving line 110 or other devices in the array substrate 100. It can be seen that the array substrate 100 provided in the embodiment of the present disclosure has a high yield rate, and when the array substrate 100 is applied to a display panel 10, the display quality of the display panel 10 is high.

Further, in this embodiment, the second static-electricity discharge portion 132 is trapezoid, and the width of the top edge of the second static-electricity discharge portion 132 is less than the width of the bottom edge of the second static-electricity discharge portion 132. Therefore, the second static-electricity discharge portion 132 and the first static-electricity discharge portion 1123 can form point discharge better, so that the static electricity released from the first static-electricity discharge portion 1123 can be better released to the second static-electricity discharge portion 132.

In addition, the width of the top edge of the second static-electricity discharge portion 132 is d₂, and the width of the bottom edge of the second static-electricity discharge portion 132 is c₂, where c₂−d₂≥2 μm. For example, c₂−d₂ may be but is not limited to 2.0 μm, 2.5 μm, 3.0 μm, 3.5 μm, 4.0 μm, 4.5 μm, 5.0 μm, 5.5 μm, or 6.0 μm.

The width of the bottom edge of the second static-electricity discharge portion 132 is c₂, and c₂ may be, but is not limited to, 5.0 μm, 5.5 μm, 6.0 μm, 6.5 μm, 7.0 μm, 7.5 μm, 8.0 μm, 8.5 μm, or 9.0 μm.

The width of the top edge of the second static-electricity discharge portion 132 is d₂, and d₂ may be, but is not limited to, 3.0 μm, 3.5 μm, 4.0 μm, 4.5 μm, 5.0 μm, 5.5 μm, 6.0 μm, 6.5 μm, or 7.0 μm.

The second static-electricity discharge portion 132 is trapezoid, the width of the top edge of the second static-electricity discharge portion 132 is d₂, and the width of the bottom edge of said second static-electricity discharge portion 132 is c₂, where c₂−d₂≥2 μm, 5 μm≤c₂≤9 μm, and 3 μm≤d₂≤7 μm. In this way, a tip may be formed between side edges and a top edge of the second static-electricity discharge portion 132, and thus the second static-electricity discharge portion 132 and the first static-electricity discharge portion 1123 can form point discharge better. As a result, the static electricity at the first static-electricity discharge portion 1123 can be released to the second static-electricity discharge portion 132 better.

In addition, the width f₂ of a portion of the first static-electricity discharge portion 1123 connected to the joint satisfies: c₂<f₂, so that when the first static-electricity discharge portion 1123 transfers the static electricity to the second static-electricity discharge portion 132, the risk of the first static-electricity discharge portion 1123 being damaged by static electricity is reduced, and the probability of product defects (the array substrate 100 and the display panel 10 to which the array substrate 100 is applied) caused by the risk of the driving line 110 being burned by static electricity are reduced.

Reference is made to FIGS. 8 and 9, the first static-electricity discharge portion 1123 has a first end surface 112a facing away from the second driving section 1122. The second static-electricity discharge portion 132 has a second end surface 130a facing away from the line body 131. The second end surface 130a is at least partially right opposite to the first end surface 112a, and a distance e₂ between the first end surface 112a and the second end surface 130a satisfies 12 μm≤e₂≤18 μm.

For example, the spacing e₂ between the second end surface 130a and the second end surface 130a may be, but is not limited to, 12 μm, 13 μm, 14 μm, 15 μm, 16 μm, 17 μm, or 18 μm.

When the distance between the first end surface 112a and the second end surface 130a is too small, even if the static electricity of the first static-electricity discharge portion 1123 may be released to the second static-electricity discharge portion 132, the too small distance between the first static-electricity discharge portion 1123 and the second static-electricity discharge portion 132 will result in that the first static-electricity discharge portion 1123 may be burned out when the static electricity is released. When the distance between the first end surface 112a and the second end surface 130a is too large, the static electricity of the first static-electricity discharge portion 1123 is not easily transmitted to the second static-electricity discharge portion 132, thereby increasing the risk of the driving line 110 and other components (such as TFT) of the array substrate 100 being damaged by static electricity.

In the array substrate 100 provided in the embodiment of the present disclosure, the distance e₂ between the first end face 112a and the second end face 130a satisfies: 12 μm≤e₂≤18 μm. The distance between the first end surface 112a and the second end surface 130a is moderate, so that on one hand, the static electricity can be easily released to the second static-electricity discharge portion 132 via the first static-electricity discharge portion 1123, and the risk of static-electricity explosion of the driving line 110 and other components of the array substrate 100 is reduced; on the other hand, the first static-electricity discharge portion 1123 is not easily burned.

In one embodiment, a centerline of the first end surface 112a coincides with a centerline of the second end surface 130a. When the centerline of the first end surface 112a and the centerline of the second end surface 130a coincide with each other, and when the static electricity is transferred to the second static-electricity discharge portion 132 via the first static-electricity discharge portion 1123, the static electricity can be transferred to the sharp corner formed by two side edges and the top edge of the second static-electricity discharge portion 132 evenly, so that the second static-electricity discharge portion 132 is not easily burned.

Further, when the first static-electricity discharge portion 1123 is arc-shaped, in a direction in which the first static-electricity discharge portion 1123 faces the second static-electricity discharge portion 132, a size h₂ of the first static-electricity discharge portion 1123 satisfies: 4 μm≤h₂≤8 μm, and 10 μm≤f₂≤14 μm.

For example, in a direction from first static-electricity discharge portion 1123 to the second static-electricity discharge portion 132, a size h₂ of the first static-electricity discharge portion 1123 may be, but is not limited to, 4 μm, 5 μm, 6 μm, 7 μm, or 8 μm. The width f₂ of a portion of the first static-electricity discharge portion 1123 connected to the joint may be, but not limited to, 10 μm, 11 μm, 12 μm, 13 μm or 14 μm.

When the first static-electricity discharge portion 1123 is arc-shaped, in a direction from the first static-electricity discharge portion 1123 to the second static-electricity discharge portion 132, a size h₂ of the first static-electricity discharge portion 1123 satisfies: 4 μm≤h₂≤8 μm; and 10 μm≤f₂≤14 μm. Therefore, the first static-electricity discharge portion 1123 can better disperse the static electricity accumulation in the driving line 110, and can better transfer the static electricity from the first static-electricity discharge portion 1123 to the second static-electricity discharge portion 132, thereby reducing or even preventing the static electricity accumulation in the array substrate 100 from causing the risk of burning or breakdown of the driving line 110 or other devices in the array substrate 100. It can be seen that the array substrate 100 provided in the embodiment of the present disclosure has a high yield rate, and when the array substrate 100 is applied to a display panel 10, the display quality of the display panel 10 is high.

It can be understood that, if the respective components of the array substrate provided in the second embodiment which are not described are the same as the corresponding components of the array substrate provided in the first embodiment, reference may be made to the description of the array substrate provided in the first embodiment, and details are not repeated herein.

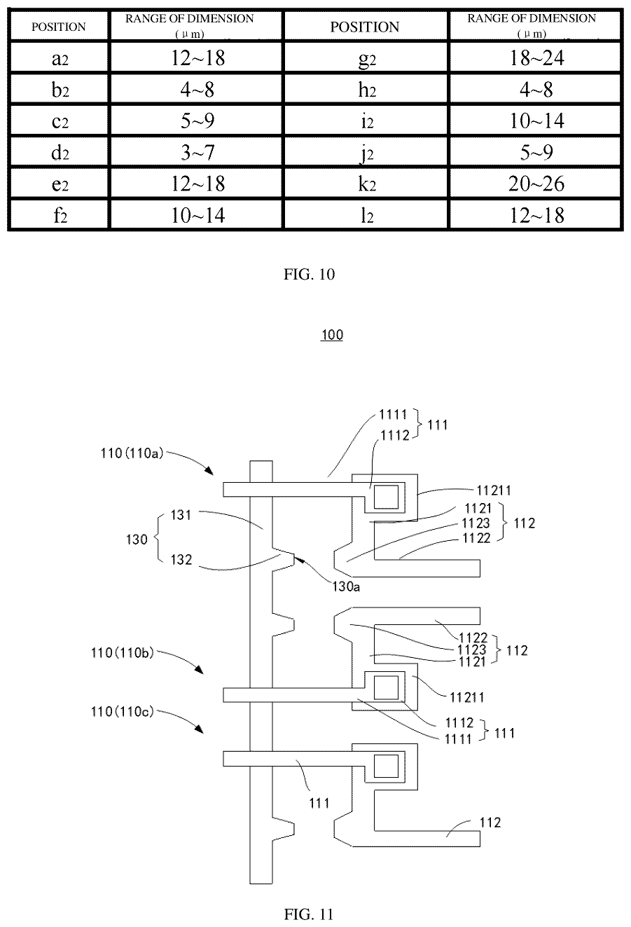

Reference is made to FIG. 10, where FIG. 10 is a dimension diagram of multiple different parts in the array substrate provided in the second embodiment of the present disclosure. For example, when the array substrate 100 is applied to a 27UD DRD display panel 10 and the thin film transistor in the array substrate 100 is a metal oxide thin film transistor, each parameter of the array substrate 100 provided in the present embodiment reduces the yield loss of the array substrate 100 due to static electricity to 0%.

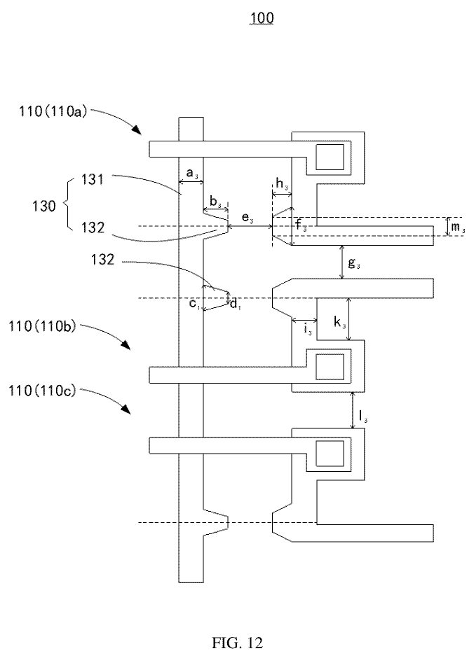

Reference is made to FIGS. 11 and 12 together, where FIG. 11 is a partial top diagram of an array substrate provided in a third embodiment of the present disclosure, and FIG. 12 is a schematic diagram illustrating detailed dimensions of the array substrate illustrated in FIG. 11. The array substrate 100 includes a driving line 110 and a static-electricity protection line 130. The driving line 110 includes a first driving sub-line 111 and a second driving sub-line 112. The first driving sub-line 111 includes a first connection portion 1112, and the second driving sub-line 112 and the first driving sub-line 111 are disposed in different layers. The second driving sub-line 112 includes a first driving section 1121, a second driving section 1122, and a first static-electricity discharge portion 1123. The first driving section 1121 includes a second connection portion 11211 at one end of the first driving section 1121. The second connection portion 11211 is electrically connected to the first connection portion 1112. The second driving section 1122 is connected to the other end of the first driving section 1121 facing away from the second connection portion 11211 in a bent manner. The first static-electricity discharge portion 1123 is located at a joint between the first driving section 1121 and the other end of the second driving section 1122. The static-electricity protection line 130 is disposed in the same layer as the second driving sub-line 112. The static-electricity protection line 130 includes a line body 131 and a second static-electricity discharge portion 132 connected to each other. The second static-electricity discharge portion 132 is opposite to and spaced apart from the first static-electricity discharge portion 1123.

Reference is made to the above description for the driving line 110 and the static-electricity protection line 130, which will not be repeated here. The first static-electricity discharge portion 1123 is trapezoid, and the second static-electricity discharge portion 132 is trapezoid.

In this embodiment, a line width a₃ of the line body 131 satisfies: 12 μm≤a₃≤18 μm.

In the present embodiment, the line width a₃ of the line body 131 may be, but is not limited to, 12 μm, 13 μm, 14 μm, 15 μm, 16 μm, 17 μm, or 18 μm.

When the line width a₃ of the line body 131 is too small, the static electricity is transferred to the line body 131 via the second static-electricity discharge portion 132, so that the line body 131 is easily burned. When the line width a₃ of the line body 131 is too large, the non-display region 10b of the display panel 10 to which the array substrate 100 is applied becomes wider. In the array substrate 100 provided in the embodiment of the present disclosure, the line length a₃ of the line body 131 of the static-electricity protection line 130 satisfies: 12 μm≤a₃≤18 μm, so that on one hand, the static electricity transferred to the line body 131 via the second static-electricity discharge portion 132 is unlikely to damage the line body 131; on the other hand, the non-display region 10b of the display panel 10 to which the array substrate 100 is applied is made narrower.

Further, the top edge of the second static-electricity discharge portion 132 has a width of d₃, and the bottom edge of the second static-electricity discharge portion 132 has a width of c₃, where c₃−d₃≥2 μm, 5 μm≤c₃≤9 μm, and 3 μm≤d₃≤7 μm.

In this embodiment, the second static-electricity discharge portion 132 is trapezoid, and the width of the top edge of the second static-electricity discharge portion 132 is less than the width of the bottom edge of the second static-electricity discharge portion 132. Therefore, the second static-electricity discharge portion 132 and the first static-electricity discharge portion 1123 can form point discharge better, so that the static electricity at the first static-electricity discharge portion 1123 can be released to the second static-electricity discharge portion 132 better.

In addition, the top edge of the second static-electricity discharge portion 132 has a width of d₃, and the bottom edge of the second static-electricity discharge portion 132 has a width of c₃, where c₃−d₃≥2 μm. For example, c₃−d₃ may be but is not limited to 2.0 μm, 2.5 μm, 3.0 μm, 3.5 μm, 4.0 μm, 4.5 μm, 5.0 μm, 5.5 μm, or 6.0 μm.

The width c₃ of the bottom edge of the second static-electricity discharge portion 132 may be, but is not limited to, 5.0 μm, 5.5 μm, 6.0 μm, 6.5 μm, 7.0 μm, 7.5 μm, 8.0 μm, 8.5 μm, or 9.0 μm.

The width d₃ of the top edge of the second static-electricity discharge portion 132 may be, but is not limited to, 3.0 μm, 3.5 μm, 4.0 μm, 4.5 μm, 5.0 μm, 5.5 μm, 6.0 μm, 6.5 μm, or 7.0 μm.

The second static-electricity discharge portion 132 is trapezoid and has a top edge with a width of d₃ and a bottom edge with a width of c₃, where c₃−d₃≥2 μm, 5 μm≤c₃≤9μm, and 3 μm≤d₃≤7 μm. In this way, a tip may be formed between side edges and a top edge of the second static-electricity discharge portion 132, and thus the second static-electricity discharge portion 132 and the first static-electricity discharge portion 1123 can form point discharge better. As a result, the static electricity at the first static-electricity discharge portion 1123 can be released to the second static-electricity discharge portion 132 better.

The first static-electricity discharge portion 1123 has a first end surface 112a facing away from the second driving section 1122. The second static-electricity discharge portion 132 has a second end surface 130a facing away from the line body 131. The second end surface 130a is at least partially right opposite to the first end surface 112a, and a distance e₃ between the first end surface 112a and the second end surface 130a satisfies: 12 μm≤e₃≤18 μm.

For example, the distance e₃ between the second end faces 130a and the first end face 112a may be, but is not limited to, 12 μm, 13 μm, 14 μm, 15 μm, 16 μm, 17 μm, or 18 μm.

When the distance between the first end surface 112a and the second end surface 130a is too small, even if the static electricity of the first static-electricity discharge portion 1123 may be released to the second static-electricity discharge portion 132, the too small distance between the first static-electricity discharge portion 1123 and the second static-electricity discharge portion 132 will result in that the first static-electricity discharge portion 1123 may be burned out when the static electricity is released. When the distance between the first end surface 112a and the second end surface 130a is too large, the static electricity of the first static-electricity discharge portion 1123 is not easily conducted to the second static-electricity discharge portion 132, thereby increasing the risk of the driving line 110 and other components (such as TFT) of the array substrate 100 being damaged by static electricity.

In the array substrate 100 provided in the embodiment of the present disclosure, the distance e₃ between the first end face 112a and the second end face 130a satisfies: 12 μm≤e₃≤18 μm. The distance between the first end surface 112a and the second end surface 130a is moderate, so that on one hand, the static electricity can be easily released to the second static-electricity discharge portion 132 via the first static-electricity discharge portion 1123, and the risk of static-electricity explosion of the driving line 110 and other components of the array substrate 100 is reduced; on the other hand, the first static-electricity discharge portion 1123 is not easily burned.

In one embodiment, a centerline of the first end surface 112a coincides with a centerline of the second end surface 130a. When the centerline of the first end surface 112a and the centerline of the second end surface 130a coincide with each other, and when the static electricity is conducted to the second static-electricity discharge portion 132 via the first static-electricity discharge portion 1123, the static electricity can be transferred to the sharp corner formed by two side edges of the second static-electricity discharge portion 132 and the top edge evenly, so that the second static-electricity discharge portion 132 is not easily burned.

In the array substrate 100 provided in the third embodiment, the first static-electricity discharge portion 1123 is trapezoid, and the second static-electricity discharge portion 132 is trapezoid. The width of the top edge of the second static-electricity discharge portion 132 is d₃, and the width of the bottom edge of the second static-electricity discharge portion 132 is c₃, where c₃−d₃≥2 μm, 5 μm≤c₃≤9 μm, and 3 μm≤d₃≤7 μm. A width f₃ of a portion of the first static-electricity discharge portion 1123 connected to the joint satisfies: c₃<f₃.

In this embodiment, the first static-electricity discharge portion 1123 is trapezoid, and the second static-electricity discharge portion 132 is trapezoid, a tip is formed between side edges and the top edge of the trapezoid. Therefore, both the first static-electricity discharge portion 1123 and the second static-electricity discharge portion 132 have tips, point discharge can be performed between the first static-electricity discharge portion 1123 and the second static-electricity discharge portion 132. The static electricity can be better transferred from the first static-electricity discharge portion 1123 to the second static-electricity discharge portion 132, thereby reducing or even preventing the static electricity accumulation in the array substrate 100 from causing the risk of burning or breakdown of the driving line 110 or other devices in the array substrate 100. It can be seen that the array substrate 100 provided in the embodiment of the present disclosure has a high yield rate, and when the array substrate 100 is applied to a display panel 10, the display quality of the display panel 10 is high.

Further, in this embodiment, the second static-electricity discharge portion 132 is trapezoid, and the width of the top edge of the second static-electricity discharge portion 132 is less than the width of the bottom edge of the second static-electricity discharge portion 132. Therefore, the second static-electricity discharge portion 132 and the first static-electricity discharge portion 1123 can form point discharge better, so that the static electricity at the first static-electricity discharge portion 1123 can be released to the second static-electricity discharge portion 132 better.

In addition, the top edge of the second static-electricity discharge portion 132 has a width of d₃, and the bottom edge of the second static-electricity discharge portion 132 has a width of c₃, where c₃−d₃≥2 μm. For example, c₃−d₃ may be, but is not limited to 2.0 μm, 2.5 μm, 3.0 μm, 3.5 μm, 4.0 μm, 4.5 μm, 5.0 μm, 5.5 μm, or 6.0 μm.

The bottom edge c₃ of the second static-electricity discharge portion 132 may be, but is not limited to, 5.0 μm, 5.5 μm, 6.0 μm, 6.5 μm, 7.0 μm, 7.5 μm, 8.0 μm, 8.5 μm, or 9.0 μm.

The top edge d₃ of the second static-electricity discharge portion 132 may be, but is not limited to, 3.0 μm, 3.5 μm, 4.0 μm, 4.5 μm, 5.0 μm, 5.5 μm, 6.0 μm, 6.5 μm, or 7.0 μm.

The second static-electricity discharge portion 132 is trapezoid and has a top edge with a width of d₃ and a bottom edge with a width of c₃, where c₃−d₃≥2 μm, 5 μm≤c₃≤9 μm, and 3 μm≤d₃≤7 μm. In this way, a tip may be formed between side edges and a top edge of the second static-electricity discharge portion 132, and thus the second static-electricity discharge portion 132 and the first static-electricity discharge portion 1123 can form point discharge better. As a result, the static electricity at the first static-electricity discharge portion 1123 can be released to the second static-electricity discharge portion 132 better.

In addition, the width f₃ of a portion of the first static-electricity discharge portion 1123 connected to the joint satisfies: c₃<f_{3,} so that when the first static-electricity discharge portion 1123 transfers the static electricity to the second static-electricity discharge portion 132, the risk of the first static-electricity discharge portion 1123 being damaged by static electricity is reduced, and the probability of product defects (the array substrate 100 and the display panel 10 to which the array substrate 100 is applied) caused by the risk of the driving line 110 being burned by static electricity are reduced.

Further, in this embodiment, the first static-electricity discharge portion 1123 is in a trapezoid shape, a top edge of the trapezoid shape has a size m₃ satisfying 8 μm≤m₃≤12 μm, and a width f₃ of the first static-electricity discharge portion 1123 connected to the connection portion satisfies 10 μm≤f₃≤14 μm. A portion of the first static-electricity discharge portion 1123 connected to the joint is the long base of the trapezoid.

For example, m₃ may be, but is not limited to, 8 μm, 9 μm, 10 μm, 11 μm, 12 μm; and f₃ may be, but is not limited to, 10 μm, 11 μm, 12 μm, 13 μm, or 14 μm.

The first static-electricity discharge portion 1123 is trapezoid, the top edge of the trapezoid shape has a size m₃ satisfying 8 μm≤m₃≤12 μm, and the width f₃ of a portion of the first static-electricity discharge portion 1123 connected to the joint (i. e. the size of the bottom edge of the trapezoid) satisfies: 10 μm≤f₃≤14 μm, so that static electricity can be better transferred to the second static-electricity discharge portion 132 via the first static-electricity discharge portion 1123, the static-electricity accumulation in the driving line 110 can be effectively dispersed, and the probability of product defects caused by the burning of the driving line 110 can be effectively reduced.

It can be understood that, if the respective components of the array substrate provided in the third embodiment which are not described are the same as the corresponding components of the array substrate provided in the first embodiment or the second embodiment, reference may be made to the description of the array substrate provided in the first embodiment or the second embodiment, and details are not repeated herein.

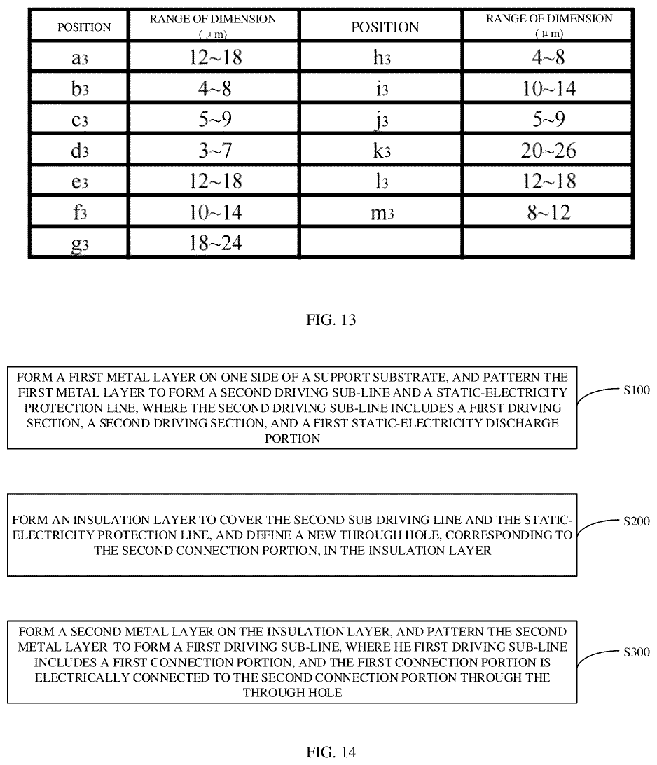

Reference is made to FIG. 13, where FIG. 13 is a dimension diagram of multiple different parts in the array substrate provided in the third embodiment of the present disclosure. For example, when the array substrate 100 is applied to a 27UD DRD display panel 10 and the thin film transistor in the array substrate 100 is a metal oxide thin film transistor, each parameter of the array substrate 100 provided in the present embodiment reduces the yield loss of the array substrate 100 due to static electricity to 0%.

Further, in combination with the array substrates 100 provided in the first, second and third embodiments, the line width iₙ of the first driving section 1121 is greater than the line width jₙ of the second driving section 1122, where n=1, 2, or 3.

The line width of the first driving section 1121 is greater than the line width of the second driving line 110b, so that static electricity on the array substrate 100 cannot easily be transferred to the joint between the second connection portion 1111 and the first connection portion 1112 through the first driving section 1121, and cannot easily damage the first driving section 1121.

In conclusion, an array substrate 100 is provided in embodiments of the present disclosure. In conclusion, the array substrate 100 provided in embodiments of the present disclosure includes the driving line 110 and the static-electricity protection line 130, the driving line 110 includes the first static-electricity discharge portion 1123, the static-electricity protection line 130 include the second static-electricity discharge portion 132, and the second static-electricity discharge portion 132 and the first static-electricity discharge portion 1123 are opposite to each other and spaced from each other. When static electricity is present in the array substrate 100 during the manufacturing process or in the usage process, the static electricity may be released to the second static-electricity discharge portion 132 via the first static-electricity discharge portion 1123, so as to reduce or even prevent the risk of burning or breaking down the driving line 110 or other devices in the array substrate 100 due to static-electricity accumulation in the array substrate 100. It can be seen that the array substrate 100 provided in embodiments of the present disclosure has a high yield rate, and when the array substrate 100 is applied to a display panel 10, the display quality of the display panel 10 is high. For example, the yield loss of the array substrate 100 including the metal oxide semiconductor TFT in the related art is about 20%, while the yield loss of the array substrate 100 provided in embodiments of the present disclosure can be reduced by a large amount, or even reduced to 0%.

A manufacturing method of the array substrate 100 provided in embodiments of the present disclosure will be briefly described below. The manufacturing method of the array substrate 100 provided in embodiments of the present disclosure may be used for manufacturing the array substrate 100 described in the above embodiments. Accordingly, the array substrate 100 described in the above embodiments can be manufactured by the manufacturing method of the array substrate 100 provided in embodiment of the present disclosure.

Reference is made to FIG. 14, where FIG. 14 is a flowchart of a manufacturing method of an array substrate provided in an embodiment of the present disclosure. The manufacturing method of the array substrate 100 includes, but not limited to, operations at S100, S200, S300, S100, S200, and S300.

At S100, a first metal layer is formed on one side of a support substrate 101, and the first metal layer is patterned to form a second driving sub-line 112 and a static-electricity protection line 130. The second driving sub-line 112 includes a first driving section 1121, a second driving section 1122, and a first static-electricity discharge portion 1123.

The support substrate 101 may be, but is not limited to, a glass substrate, and the first metal layer may be, but is not limited to, a pure metal, an alloy, or the like. The material of the first metal layer may be, but not limited to, one or more of Cu, Mo, Al, Ti, Nb, and Mg. The first metal layer may be of a single layer or multiple layers (e. g., two or more layers).

The first metal layer may be formed by, but not limited to, magnetron sputtering. Patterning the first metal layer may include, but not limited to, processes such as exposing, developing, and wet etching stripping.

At S200, an insulation layer 120 is formed to cover the second sub driving line 112 and the static-electricity protection line 130, and a new through hole 121, corresponding to the second connection portion 11211, is defined in the insulation layer 120.

Specifically, the insulation layer 120 is also referred to as an insulation medium layer or an insulation dielectric layer. The insulation layer 120 may be, but is not limited to, formed by chemical vapor deposition.

The material of the insulation layer 120 may include, but is not limited to, one or more of silicon oxide, silicon nitride, and silicon oxynitride. The number of the insulation layers 120 may be, but is not limited to, one, or two or more than two. In one embodiment, when there are multiple insulation layers 120, among the multiple insulation layers 120, an insulation layer 120 close to the second driving sub-line 112 is one of two film layers: silicon nitride film layer and silicon oxynitride film layer, and an insulation layer 120 facing away from the second driving sub-line 112 is a silicon oxide film layer.

The through hole 121 can be defined in the insulation layer 120 by processes such as coating, exposing, developing, dry etching or the like.

At S300, a second metal layer is formed on the insulation layer 120, and the second metal layer is patterned to form a first driving sub-line 111. The first driving sub-line 111 includes a first connection portion 1112, and the first connection portion 1112 is electrically connected to the second connection portion 1121 through the through hole 121.

The first metal layer may be, but is not limited to, a pure metal, an alloy, or the like, and the material of the first metal layer may be, but is not limited to, one or more of Cu, Mo, Al, Ti, Nb, and Mg. The first metal layer may be of a single layer or multiple layers (e. g., two or more layers).

The second metal layer may be formed by, but is not limited to, magnetron sputtering. Patterning the second metal layer may include, but is not limited to, processes such as exposing, developing, and wet etching stripping.

It can be seen that, compared with the manufacturing method of the array substrate 100 provided in the related art, the manufacturing method of the array substrate 100 provided in embodiments of the present disclosure does not change materials and process conditions, and thus no additional cost is increased.

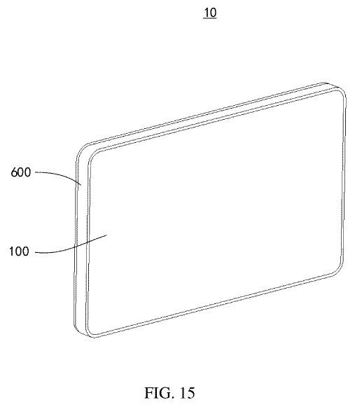

An embodiment of the present disclosure further provides a display panel 10. Reference is made to FIG. 15, where FIG. 15 is a schematic diagram of a display panel provided in an embodiment of the present disclosure. The display panel 10 includes the array substrate 100 according to any one of the above embodiments, and reference of the array substrate 100 can be made to the above description and will not be repeated herein.

The display panel 10 may be, but is not limited to, an LCD display panel, or the display panel 10 may be an OLED display panel, a mini-LED display panel, or the like.

In the schematic diagram of the present embodiment, the display panel 10 further includes a housing 600 as an example. The housing 600 is configured to support the array substrate 100, which may not be understood as a limitation to the display panel 10 and the array substrate 100 provided in embodiments of the present disclosure.

Although embodiments of the present disclosure have been illustrated and described, it may be understood that the above embodiments are illustrative and cannot be construed as limitations to the present disclosure. Those skilled in the art can make changes, modifications, replacements, and variations to the above embodiments within the scope of the present disclosure, and these changes and modifications shall also fall within the scope of protection of the present disclosure.

What is claimed is:

1. An array substrate, comprising:
a driving line comprising a first driving sub-line and a second driving sub-line, wherein the first driving sub-line has a first connection portion, the second driving sub-line and the first driving sub-line are disposed in different layers, the second driving sub-line comprises a first driving section, a second driving section, and a first static-electricity discharge portion, the first driving section comprises a second connection portion at one end of the first driving section, the second connection portion is electrically connected to the first connection portion, the second driving section is connected to another end of the first driving section facing away from the second connection portion in a bent manner, the first static-electricity discharge portion is located at a joint of the another end first driving section and the second driving section; and
a static-electricity protection line disposed in the same layer as the second driving sub-line, wherein the static-electricity protection line comprises a line body and a second static-electricity discharge portion connected to the line body, and the second static-electricity discharge portion and the first static-electricity discharge portion are opposite to and spaced apart from each other.

2. The array substrate of claim 1, wherein a line width a of the line body satisfies: 12 μm≤a≤18 μm.

3. The array substrate of claim 2, wherein the first static-electricity discharge portion is rectangular and the second static-electricity discharge portion is trapezoid; and
a width of a top edge of the second static-electricity discharge portion is d₁, a width of a bottom edge of the second static-electricity discharge portion is c₁, c₁−d₁≥2 μm, 5 μm≤c₁≤9 μm, and 3 μm≤d₁≤7 μm.

4. The array substrate of claim 2, wherein the first static-electricity discharge portion has a first end surface facing away from the second driving section, the second static-electricity discharge portion has a second end surface facing away from the line body, the second end surface and the first end surface are at least partially right opposite to each other, and a distance e₁ between the first end surface and the second end surface satisfies: 12 μm≤e₁≤18 μm.

5. The array substrate of claim 4, wherein the width d₁ of the second end surface and a width f₁ of the first end surface satisfy: d₁<f₁; 3 μm≤d₁≤7 μm, and 7 μm≤f₁≤11 μm.

6. The array substrate of claim 1, wherein a distance k₁ from the second connection portion to the second driving section satisfies: 20 μm≤k₁≤26 μm.

7. The array substrate of claim 2, wherein the first static-electricity discharge portion is arc-shaped or trapezoidal, and the second static-electricity discharge portion is trapezoidal; a width of a top edge of the second static-electricity discharge portion is d₂, and a width of a bottom edge of the second static-electricity discharge portion is c₂, c₂−d₂≥2 μm, 5 μm≤c₂≤9 μm, 3 μm≤d₂≤7 μm; and a width f₂ of a portion of the first static-electricity discharge portion connected to the joint satisfies: c₂<f₂.

8. The array substrate of claim 7, wherein when the first static-electricity discharge portion is arc-shaped, in a direction form the first static-electricity discharge portion to the second static-electricity discharge portion, a size h₂ of the first static-electricity discharge portion satisfies: 4 μm≤h₂≤8 μm, and 10 μm≤f₂≤14 μm.

9. The array substrate of claim 1, wherein a line width of the first driving section is greater than a line width of the second driving section.

10. A display panel, wherein the display panel comprises an array substrate, and the array substrate comprises:
a driving line comprising a first driving sub-line and a second driving sub-line, wherein the first driving sub-line has a first connection portion, the second driving sub-line and the first driving sub-line are disposed in different layers, the second driving sub-line comprises a first driving section, a second driving section, and a first static-electricity discharge portion, the first driving section comprises a second connection portion at one end of the first driving section, the second connection portion is electrically connected to the first connection portion, the second driving section is connected to another end of the first driving section facing away from the second connection portion in a bent manner, the first static-electricity discharge portion is located at a joint of the another end first driving section and the second driving section; and
a static-electricity protection line disposed in the same layer as the second driving sub-line, wherein the static-electricity protection line comprises a line body and a second static-electricity discharge portion connected to the line body, and the second static-electricity discharge portion and the first static-electricity discharge portion are opposite to and spaced apart from each other.

11. The display panel of claim 10, wherein a line width a of the line body satisfies: 12 μm≤a≤18 μm.

12. The display panel of claim 11, wherein the first static-electricity discharge portion is rectangular and the second static-electricity discharge portion is trapezoid; and a width of a top edge of the second static-electricity discharge portion is d₁, a width of a bottom edge of the second static-electricity discharge portion is c₁, c₁−d₁≥2 μm, 5 μm≤c₁≤9 μm, and 3μm≤d₁≤7 μm.

13. The display panel of claim 11, wherein the first static-electricity discharge portion has a first end surface facing away from the second driving section, the second static-electricity discharge portion has a second end surface facing away from the line body, the second end surface and the first end surface are at least partially right opposite to each other, and a distance e₁ between the first end surface and the second end surface satisfies: 12 μm≤e₁≤18 μm.

14. The display panel of claim 13, wherein the width d₁ of the second end surface and a width f₁ of the first end surface satisfy: d₁<f₁; 3 μm≤d₁≤7 μm, and 7 μm≤f₁≤11 μm.

15. The display panel of claim 10, wherein a distance k₁ from the second connection portion to the second driving section satisfies: 20 μm≤k₁≤26 μm.

16. The display panel of claim 11, wherein the first static-electricity discharge portion is arc-shaped or trapezoidal, and the second static-electricity discharge portion is trapezoidal; a width of a top edge of the second static-electricity discharge portion is d₂, and a width of a bottom edge of the second static-electricity discharge portion is c₂, c₂−d₂≥2 μm, 5 μm≤c₂≤9 μm, 3 μm≤d₂≤7 μm; and a width f₂ of a portion of the first static-electricity discharge portion connected to the joint satisfies: c₂<f₂.

17. The display panel of claim 16, wherein when the first static-electricity discharge portion is arc-shaped, in a direction form the first static-electricity discharge portion to the second static-electricity discharge portion, a size h₂ of the first static-electricity discharge portion satisfies: 4 μm≤h₂≤8 μm, and 10 μm≤f₂≤14 μm.

18. The display panel of claim 10, wherein a line width of the first driving section is greater than a line width of the second driving section.
